(19) United States
(12) Patent Application Publication
(10) Pub. No.: US 2013/0046576 A1
(43) Pub. Date: Feb. 21, 2013

(54) SYSTEM, APPARATUS AND METHOD FOR BRAND PAIRING

(71) Applicants: Gregory Brian Artzt, Matthews, NC (US); Levon Lloyd, Columbia, MD (US); Simon Lockwood Walsh, Port Washington, NY (US)

(72) Inventors: Gregory Brian Artzt, Matthews, NC (US); Levon Lloyd, Columbia, MD (US); Simon Lockwood Walsh, Port Washington, NY (US)

(21) Appl. No.: 13/586,840

(22) Filed: Aug. 15, 2012

Related U.S. Application Data
(60) Provisional application No. 61/524,243, filed on Aug. 16, 2011.

(51) Int. Cl. G06Q 30/02

(52) U.S. Cl. 705/7.29

(57) ABSTRACT

A computer-implemented method for performing marketing research using social and information analytics. The computer is specifically programmed for performing the steps of collecting user-generated content that is associated with a user; and determining if the user-generated content contain a predetermined topic and if it does, storing the user-generated content and user information associated with the user in an audience database associated with the predetermined topic. The method may further includes receiving from a researcher computer a master topic; determining a master user list of user information associated with the master topic and for each of the plurality of the predetermined topics except for the master topic, determining the correlation between the user associated with the master topic and the users associated with each of the other predetermined topics to provide a ranked list of interests for users interested in the master topic.

### CROSS-REFERENCE TO RELATED APPLICATIONS

This application claims the benefit of the filing date of U.S. Provisional Patent Application No. 61/524,243 filed on Aug. 16, 2011, the disclosure of which is hereby incorporated herein by reference.

### TECHNICAL FIELD

This invention relates to computer systems and methods for performing marketing research using social and information analytics based on user-generated content.

### BACKGROUND OF THE INVENTION

In the current information age, companies spend over 100 billion dollars per year advertising their industry, company, and/or products. The products may be advertised by TV, radio, newsprint, magazine, outdoors billboard, or on-line. In order to increase sales, companies and advertisers look for new consumers and try to create advertisements that will reach the company's target audience. However in order to reach the company's target audience, it is necessary to understand who is the company's target audience and the interests of the target audience. Many companies use information gathered by Nielsen Media Research to determine their target audience, to determine the interests of their target audience, and/or to position their products in the marketplace. However the information gathered by Nielsen Media Research is a statistical representation of data polled from a limited pre-selected group of people. This information may be biased based on the selection of the pre-selected group, the questions posed to the pre-selected group during the polling, and the timing of the polling.

To be more efficient and effective with its advertising, it would be helpful for a company to know what type of advertising, TV, radio, print, etc., works best for their product and what show, radio station, and/or magazine people in their target audience are most interested in and look at or listen to the most. To better reach the company's target audience, it would also be helpful to know when and what new interests are emerging. To increase consumers, it would be helpful for a company to know who is interested in similar or related products. It would be helpful to know who, in addition to being interested in, actually purchases the company's and/or the competitor's products and how they feel about those products and how strong that feeling is.

Accordingly, there is a need to gather more accurate information about audiences and their interests so that companies can know more about their target audience and be more efficient with their advertising.

### SUMMARY OF THE INVENTION

One aspect of the present invention includes a computer-implemented method for performing marketing research using social and information analytics. In another aspect of the present invent, a server computer is specifically programmed for performing the method for marketing research. The method for marketing research includes the step of collecting user-generated content that is associated with a user from a data network. The method further includes the steps of, for each of a plurality of predetermined topics, determining if the user-generated content contains the predetermined topic and if it does, storing the user-generated content and user information associated with the user in an audience database associated with the predetermined topic. In one embodiment, the user-generated content includes following at least one of the plurality of predetermined topics. In one embodiment, the user information includes identity information. The user information may include post information determined from the user-generated content.

In a preferred embodiment of the present invention, the method includes the step of receiving from a researcher computer a master topic. The master topic may include one or more of the plurality of predetermined topics. The method further includes the steps of determining a master user list of user information associated with the master topic and, for each of the plurality of the predetermined topics except for the master topic, determining secondary user lists of user information associated with each of the predetermined topic. The master user list and the secondary user lists may be determined from user information stored in the audience database associated with each predetermined topic. The method includes for each of the plurality of the predetermined topics except for the master topic, determining a correlation associated with the predetermined topic and storing the predetermined topic and its associated correlation in a master topic affinity table. The method also includes the step of transmitting to the researcher computer marketing research information determined from the master topic affinity table. In one embodiment, the correlation associated with the predetermined topic includes at least one match between user information in the master user list and user information in the secondary user list associated with the predetermined topic.

In another embodiment, the method may further include limiting the predetermined topics stored in the master topic affinity table based on the correlation being greater than or less than a threshold. The threshold may be input by the researcher. The method may further include formatting, or ordering, the marketing research information determined from the master topic affinity table based on the value of the correlation.

In another embodiment, the user information may include post information determined from the user-generated content and the method further includes storing an accumulation of the post information in the master topic affinity table. The post information may include a sentiment associated with the predetermined topic, characteristics of language associated with the predetermined topic, purchase intent information associated with the predetermined topic, the klout of the user, demographic data about the user associated with the user-generated content, a timeframe of the user-generated content. The accumulation of the post information may be an addition or an average of the post information for each user-generated content. The method may include receiving from the researcher computer a user information selection and formatting the marketing research information based on the user information selection. Furthermore, the method may include receiving from the researcher computer an accumulation selection and the accumulation of the user information is based on the accumulation selection. The accumulation selection may be, for example, a time limitation or a demographic limitation that causes only user information meeting the accumulation selection to be accumulated in the master topic affinity table.

### BRIEF DESCRIPTION OF THE DRAWING

The aforementioned and other aspects, features and advantages can be more readily understood from the following detailed description with reference to the accompanying drawings wherein:

FIG. 1 shows a block diagram of a system, according to an exemplary embodiment;

FIG. 2 illustrates the relationship of data components in an exemplary embodiment;

FIG. 3 illustrates a flowchart of a method of an exemplary embodiment performed by the system of the present invention;

FIG. 4 shows a flow diagram of data components in a system, according to an exemplary embodiment;

FIG. 5 illustrates the relationship of master topic components in an exemplary embodiment;

FIG. 6 illustrates a flowchart of a method of an exemplary embodiment performed by the system of the present invention;

FIG. 7 illustrates a flowchart of a method of an exemplary embodiment performed by the system of the present invention; and

FIG. 8 depicts an example of a researcher interface screen, according to an exemplary embodiment.

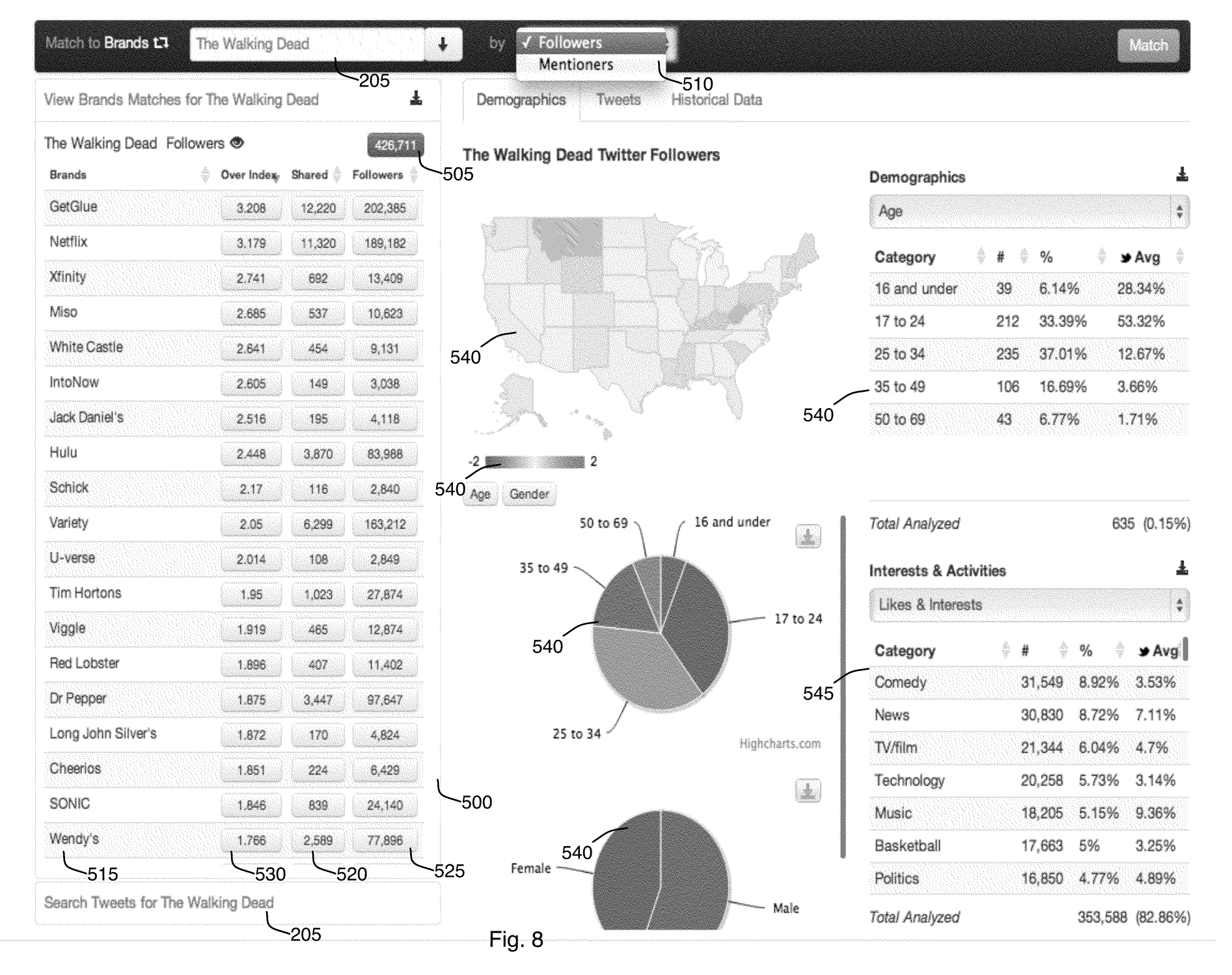

### DESCRIPTION OF THE PREFERRED EMBODIMENTS

Before the present invention is described, it is to be understood that this disclosure is not limited to the particular embodiments described, as these may vary. It is also to be understood that the terminology used in the description is for purposes of describing the particular versions or embodiments only, and is not intended to limit the scope. It is to be understood that each specific element includes all technical equivalents that operate in a similar manner. In addition, a detailed description of known functions and configurations will be omitted when it may obscure the subject matter of the present invention.

Referring now to the drawings, wherein like reference numerals designate identical or corresponding parts throughout the several views. One aspect of the present invention is methods of performing marketing research. The methods, as described below, include collecting user-generated content and determining audiences of predetermined topics from the user-generated content; and determining information about the audience of the predetermined topic selected by a researcher and transmitting the information to the researcher. As used in this disclosure, user-generated content is defined as any content provided by any user to any data network; an audience of topic is defined as one or more users who are interested in a topic, where interest is correlated to any information on a data network related to the topic; and information about the audience is defined as any knowledge about the audience gleaned from collected user-generated content.

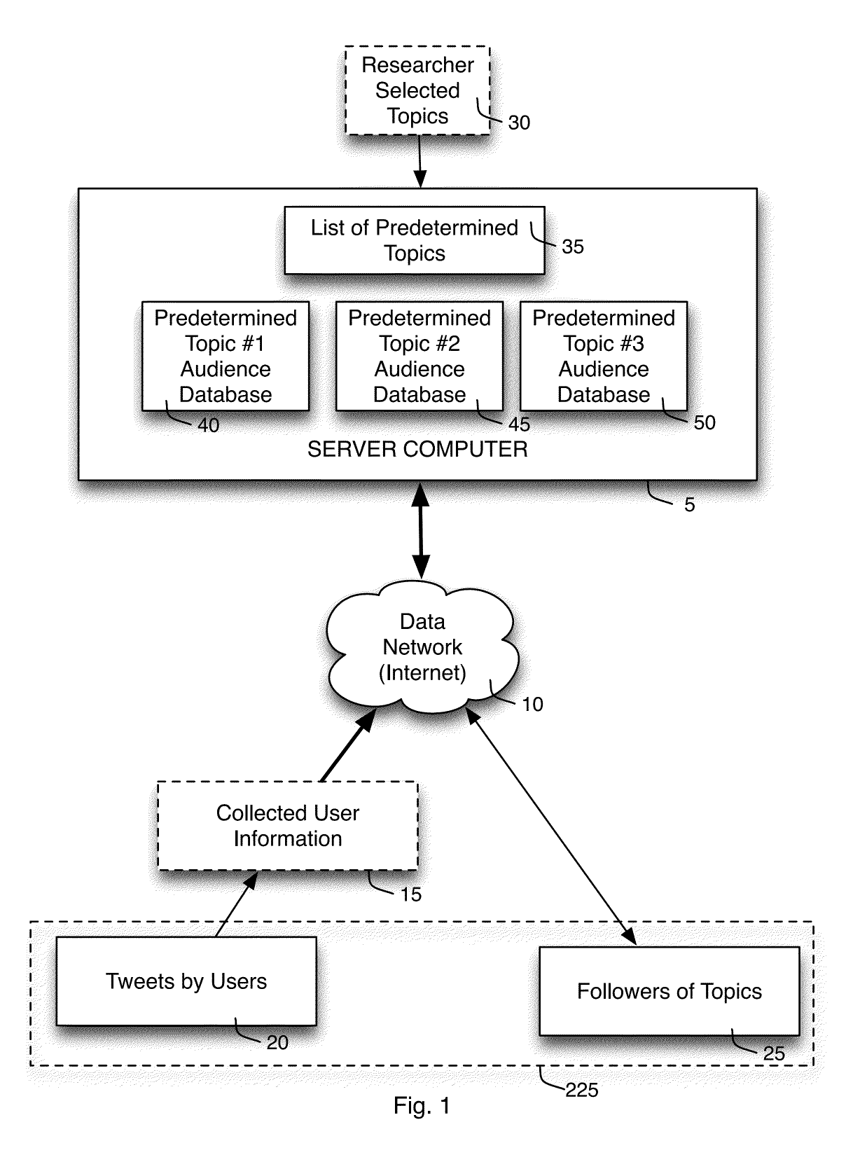

Shown in FIG. 1, one aspect of the present invention includes a server computer 5 programmed to execute the method of performing marketing research. The server computer 5 is connected to a data network 10 (for example the Internet) and collects user-generated content 225 from the data network 10. This disclosure will describe the user-generated content 225 from Twitter, specifically tweets 20 and followers of topics 25, however it should be understood that user-generated content 225 may be generated on news websites, social networking websites (such as Facebook), bulletin board websites, websites with discussion forums and/or comments sections, blog websites, editorial websites, status update websites, personal websites, and so forth. The user-generated 225 content may correspond to any content on such websites. In addition, the user-generated content 225 may be collected, formatted, and provided to the server computer 5 by social media monitoring services, such as GNIP, Spinn3r, or Datashift. GNIP, for example, provides Twitter Decahose, which is a stream of metadata that contains the tweets by users 20 and user information 15 associated with each user tweet 20. Similarly, Twitter API provides an identification list of all followers of a topic 25.

As shown in FIG. 1, the server computer 5 may contain data storage for a list of predetermined topics 35 and audience databases 40, 45, and 50 for each of the predetermined topics in the list of predetermined topics 35 (FIG. 1 shows three predetermined topics as an example, but this is an arbitrary number of predetermined topics and it should be understood that the number of predetermined topics may be hundred, thousands, or more). In order to determine an audience of a predetermined topic from the user-generated content 225, the server computer 5 searches the user-generated content 225 for each predetermined topic in the list of predetermined topics 35 and when the user-generated content 225 contains the predetermined topic, the server computer 5 stores it and user information 15 associated with it in the audience database associated with the predetermined topic 40, 45, and 50. The list of predetermined topics 35 may include predetermined topics selected by programmers during manufacture and/or researcher selected topics 30 received by the server computer 5. The researcher-selected topics 30 may be received from a terminal connected to the server computer 5 or the researcher selected topics 30 may be received via email, text, posts on websites, or other similar communications by a researcher. A predetermined topic may be anything or any combination of things including: TV shows, brands, sports teams, actors, types of advertising, or products (such as drinks, foods, phones or cars).

The server computer 5 is configured to isolate, into different audience databases 40, 45, and 50 (also called buckets), for example, (a) viewers of different television shows, (b) advocates for different brands and products, and/or (c) people actively discussing different topics, based on the user generated content 225 received by the server computer 5. As an example of (a), the server computer 5 may process the user generated content 225 to determine all the users that have viewed and or discussed a particular television show, based on the user generated content. For example, the server computer 5 may collect any information by users discussing a particular basketball sports update show from news websites, social networking websites (such as Facebook), bulletin board websites, websites with discussion forums and/or comments sections, blog websites, editorial websites, status update websites (such as Twitter), personal websites, and so forth. The information by the users (and any other information corresponding to these users that can be obtained) is collected into a bucket corresponding to the basketball sports update show. Then the process is repeated for a different type of television show, such as a Peruvian cooking television show. While these examples of (a) refer to television shows, it should be understood that a similar process can be employed to group into buckets information from (b) advocates for different brands and products (such as a drink, food, phone or car), and/or (c) people actively discussing any variety of different topics.

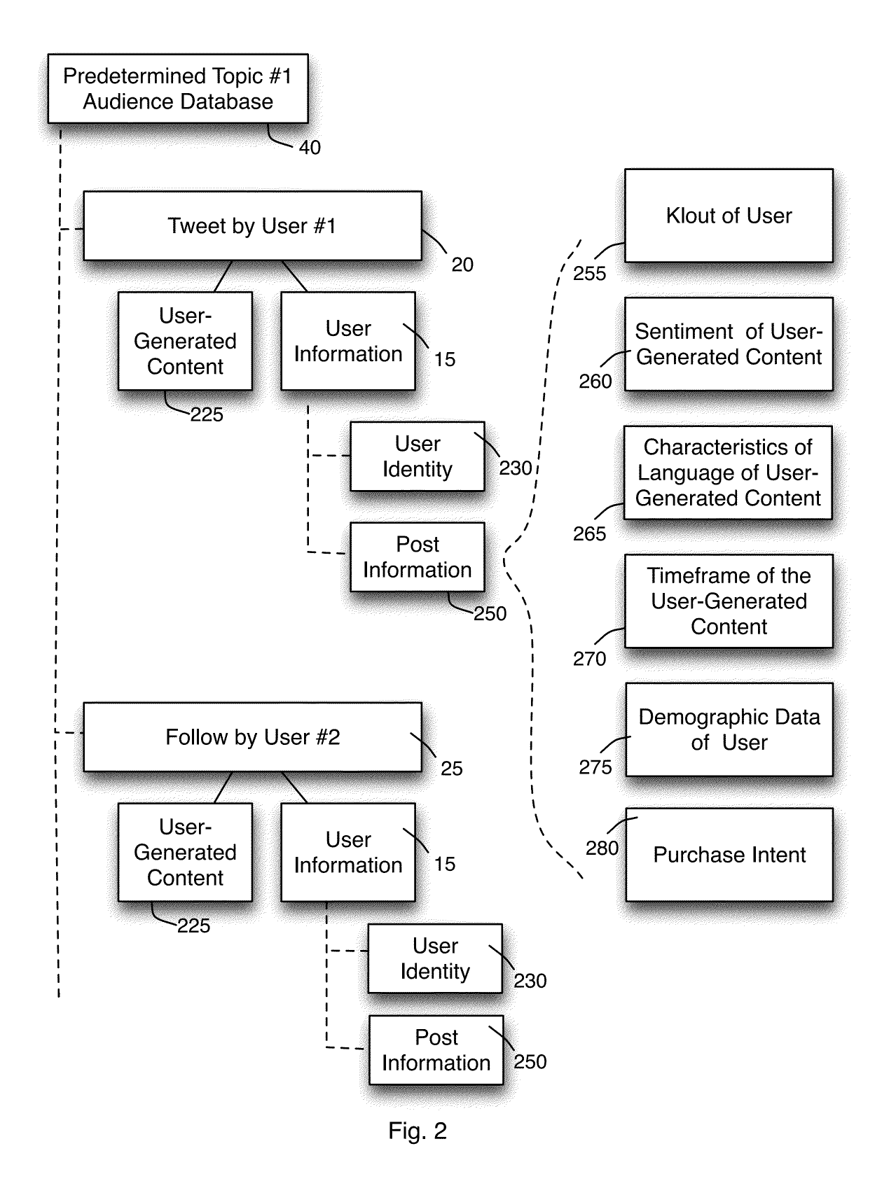

Each predetermined topic audience database 40, 45, and contains user-generated content 225 and user information 15 Referring to FIG. 2, the data organization for a predetermined topic audience database 40 is shown. It should be understood that there may be many predetermined topic audience databases. FIG. 2 shows the user-generated content 225 and user information 15 for a tweet by user #1 20 and the user-generated content 225 and user information 15 for a follower of the predetermined topic 25. The user-generated content 225 stored in the audience database 40 may be the text of the tweet 20. The user information 15 stored in the audience database 40 may include information about the identity 230 of the user inputting the user-generated content 225. This may be a Twitter handle, Twitter Hashtags, keywords (text strings), or any similar identifying name or number. The audience of a predetermined topic is the collection of the users having stored user information 15 in the audience database of the predetermined topic 40. The audience databases 40 may be updated (or added to) every time the server computer 5 collects user-generated content 225 from the data network 10. The server computer 5 may include a web crawler to spider websites connected to the data network 10, as known by one skilled in the art. The server computer 5 may collect the user-generated content 225 from any devices connected to the data network 10. The devices may be operated by users and may correspond to personal computers, workstations, client terminals or mobile devices connected to the data network 10. The list of predetermined topics 35 and the audience databases 40, 45, and 50 may be stored in the server computer's 5 local memory storage or in memory storage accessed through the data network 10, i.e. cloud data storage (not shown). The user-generated content 225 and the user information 15 may be stored in an audience database 40, 45, and 50 with contiguous memory locations (as shown in FIG. 1) or in non-contiguous memory locations that are tagged with audience database identifiers (not shown). The storage of the user-generated content 225 and user information 15 in audience databases 40, 45, and 50 associated with predetermined topics may be considered bucketing the user-generated content 225.

The user information 15 may also include post information 250, such as klout of the user 255, sentiment of user-generated content 260, characteristics of language of the user-generated content 265, timeframe of the user-generated content 270, demographic data of the user 275, and/or purchase intent 280. It should be understood that the post information 250 may include anything that describes the user or the user-generated content 225. The post information 250 may be gathered and provided to the server computer 5 by a social media monitoring service as described above, may be collected by the server computer 5 from spidering different websites, or may be determined by the server computer 5. For example, the klout of a user 255, which may be the number of people that follow the user on Twitter or the number of people the user is LinkedIn with or is friends with on Facebook, may be provided to the server computer 5 from different websites, while the characteristics of language of the user-generated content 265 or purchase intent 280 may be determined by the server computer 5 using NLP analysis on the user-generated content 225, as known by one skilled in the art. In the embodiment where the user follows a predetermined topic 25, the user-generated content 225 may only be an indication of the following rather than actual content. Similarly, the post information 250 may only include information about the user. It should be understood that the post information 250 may be gathered from previously stored user-generated content 225 and other sources. Any information where the user identity 230 is the same may be captured and stored as post information 250. Knowledge of the user identity 230 allows the present invention to categorize interests of the user that may be gathered at various times and from various sources. The gathered interests of actual users, rather than a time correlation of topics that assumes a relationship, allows the researcher to discover new interests and emerging trends that are not possible by looking at small time windows. As described above the user identity 230 may be a Twitter handle or any other identifying name (typically not the users actual name). User-generated content (conversations, tweets, followings, etc.) from a particular user can be collected in real-time or can be retrieved from stored user-generated content previously collected, for example from the past few years.

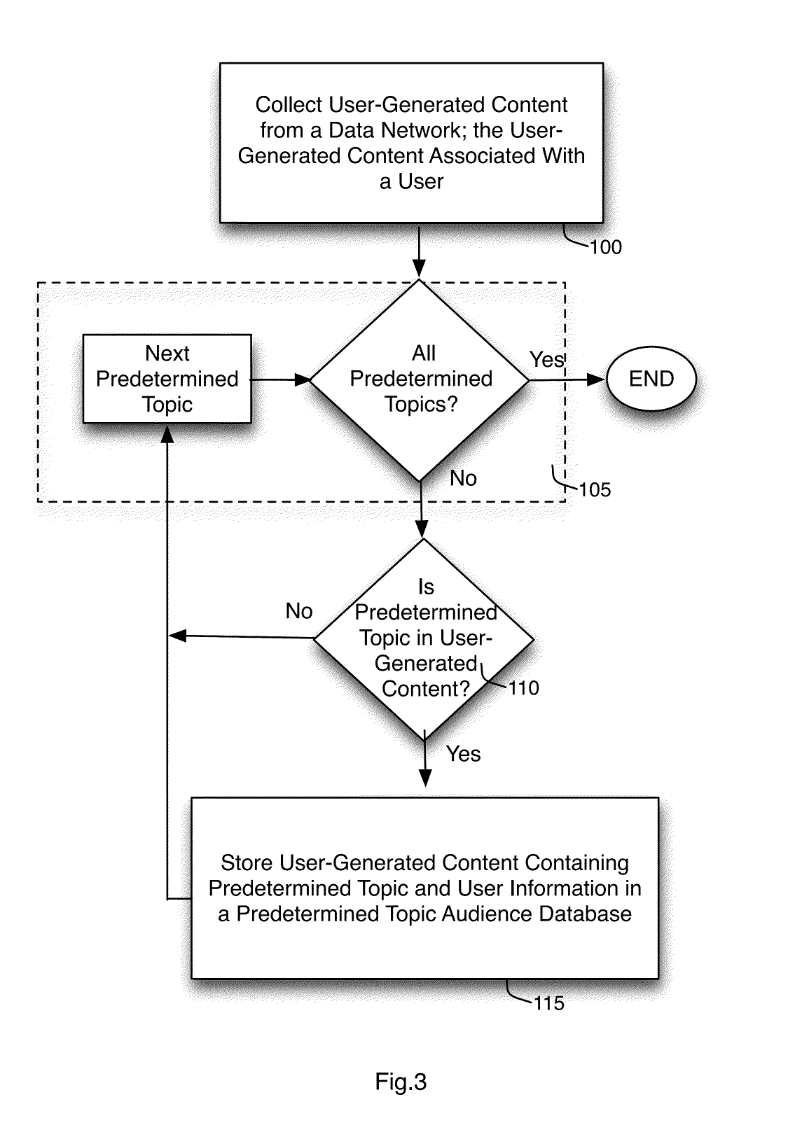

Referring to FIG. 3, a flowchart for the method of the present invention is shown. As described above, the method of performing marketing research includes the step of collecting the user-generated content 225 (step 100) from the data network 10. This step may occur every week, every day, every hour, or continuously. The collected user-generated content 225 may be stored for later processing or may be processed as it is collected. After collecting the user-generated content 225 (step 100) from the data network 10 the method loops through each of the predetermined topics (step 105) to determine if the user-generated content 225 includes the predetermined topic (step 110). As described above, the predetermined topic may be any topic programmed into the server computer 5 and the determining of whether the predetermined topic is in the user-generated content 225 may be accomplished using NLP analysis. If the predetermined topic is a newly programmed topic and the collected user-generated content 225 has been stored, the server computer 5 may search all the stored user-generated content 225 only for the newly programmed predetermined topic, rather than all predetermined topics. If the user-generated content 225 (previously stored and/or just collected) contains the predetermined topic (step 110), the user-generated content 225 and user information 15 is stored in an audience database associated with the predetermined topic 40, 45 or 50 (step 115). The user information 15 includes user identity information 230 and may also include post information 250 (see FIG. 2).

By way of example, the storage and processing of user-generated content 225 from Twitter API and Twitter Decahose will be described. The server computer 5 accesses the Twitter website and downloads Twitter API data for a topic. The Twitter API data contains a list of the identity of all current followers of the topic. The server computer 5 compares the list of the current followers with a stored list containing the identity of followers 230 of the predetermined topic previously downloaded and adds or deletes any changes. The server computer 5 may insert or update, depending on whether the follower is newly stored in the predetermined topics audience databases 40, 45, or 50, the user identity 230 in the audience database 40 and any post information 250 about the follower 25 that was previously collected and stored in any of the audience databases 40, 45, and 50. The Twitter Decahose is provided by GNIP and allows the server computer 5 to download and store all tweets and information related to the tweets. The server computer 5 parses the tweet from the information received from GNIP and determines if any of the predetermined topics in the predetermine topics list is in a tweet and stores (or tags) the tweet and the user identity information 15 associated with the tweet 20 in the audience database associated with the predetermined topic 40, 45, and 50. The server computer 5 may also build a map that identifies a list of all predetermined topics a particular user mentions in any tweet 20. The server computer 5 may also store post information 250 downloaded directly from the Twitter Decahose or information that has been determined from the tweet 20. As described above, the post information 250 may include demographic and psychographic information 275, characteristics of language 265, sentiment 260, purchase intent 280, etc. The demographic information 275 may include profession, gender, age, family status, race/ethnicity, employment status, and location. The psychographic information may include likes and interests, account categories followed, accounts followed, Twitter activity, klout score, Twitter Followers, time on Twitter, Tweets count, and platform used to tweet. The sentiment 260, purchase intent 280 and characteristics of language 265 may be determined by analyzing the tweet 20. Sentiment analysis may be performed as described in U.S. Pat. No. 7,996,210, the disclosure of which is incorporated by reference herein.

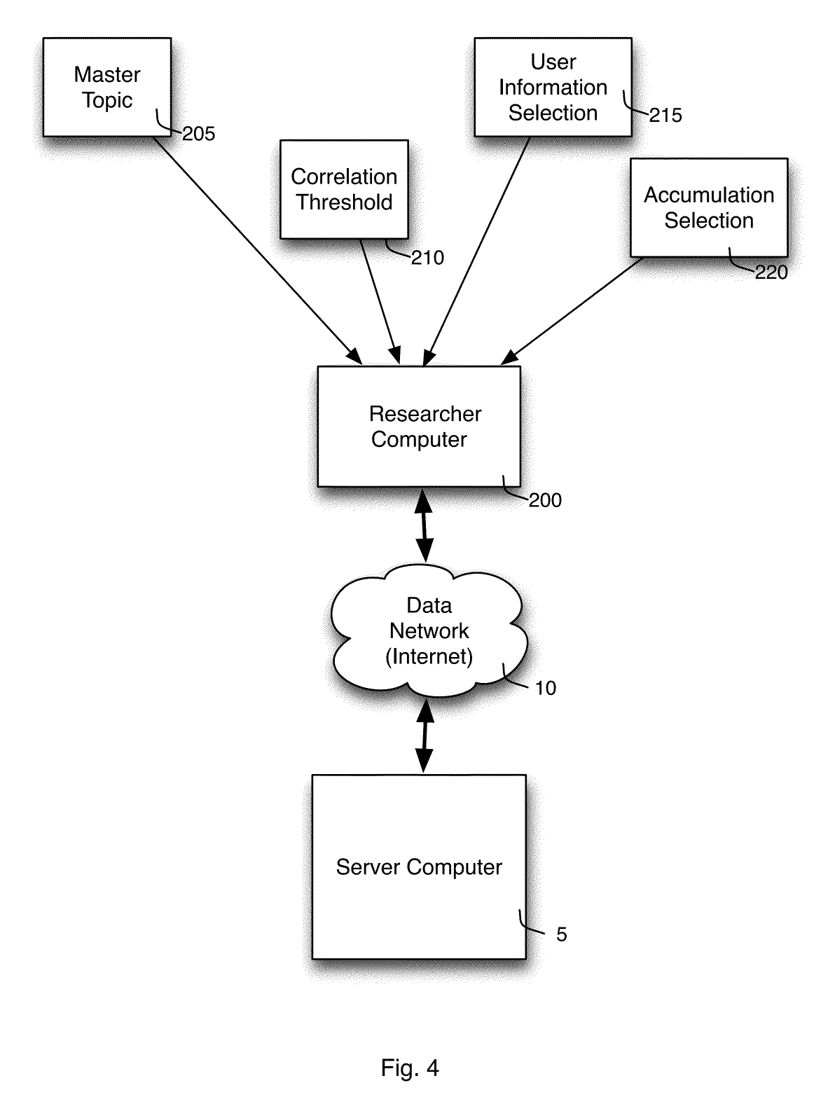

Referring to FIG. 4, a data flow diagram of another embodiment of the present invention is shown. In this embodiment, a researcher (not shown) inputs a master topic 205 into a researcher computer 200. The master topic 205 may be selected from a list of predetermine topics which are provided by the server computer 5 over the data network 10 to the researcher computer 200. An example of a webpage displaying the master topic 205 and the results of the method of this embodiment is described below. The researcher computer 200 transmits the master topic 205 to the server computer 5 over the data network 10. When the server computer 5 receives the master topic 205, such as a television network, television show, industry, brand and/or product, etc., the server computer 5 matches the researcher selection with one of the predetermined topics or buckets. For example, the server computer 5 may match the selection of the hybrid car from the car manufacturer with a bucket containing all the information and user generated content 225 from the Internet regarding that hybrid car from that car manufacturer. If no predetermined topic audience (or bucket) exists, the server computer 5 may collect the user-generated content 225 for the master topic, as described above. The server computer 5 then processes the user-generated content 225 in the matched predetermined topic audience (or bucket), now the master topic audience, to find correlations between the master topic 205 users and the users in each of the other predetermined topics as described below. The server computer 5 will then use the correlations to determine marketing research information about the audience of the master topic 205 and provide the marketing research information back to the researcher computer 200 over the data network 10, which is then displayed to the researcher as described below.

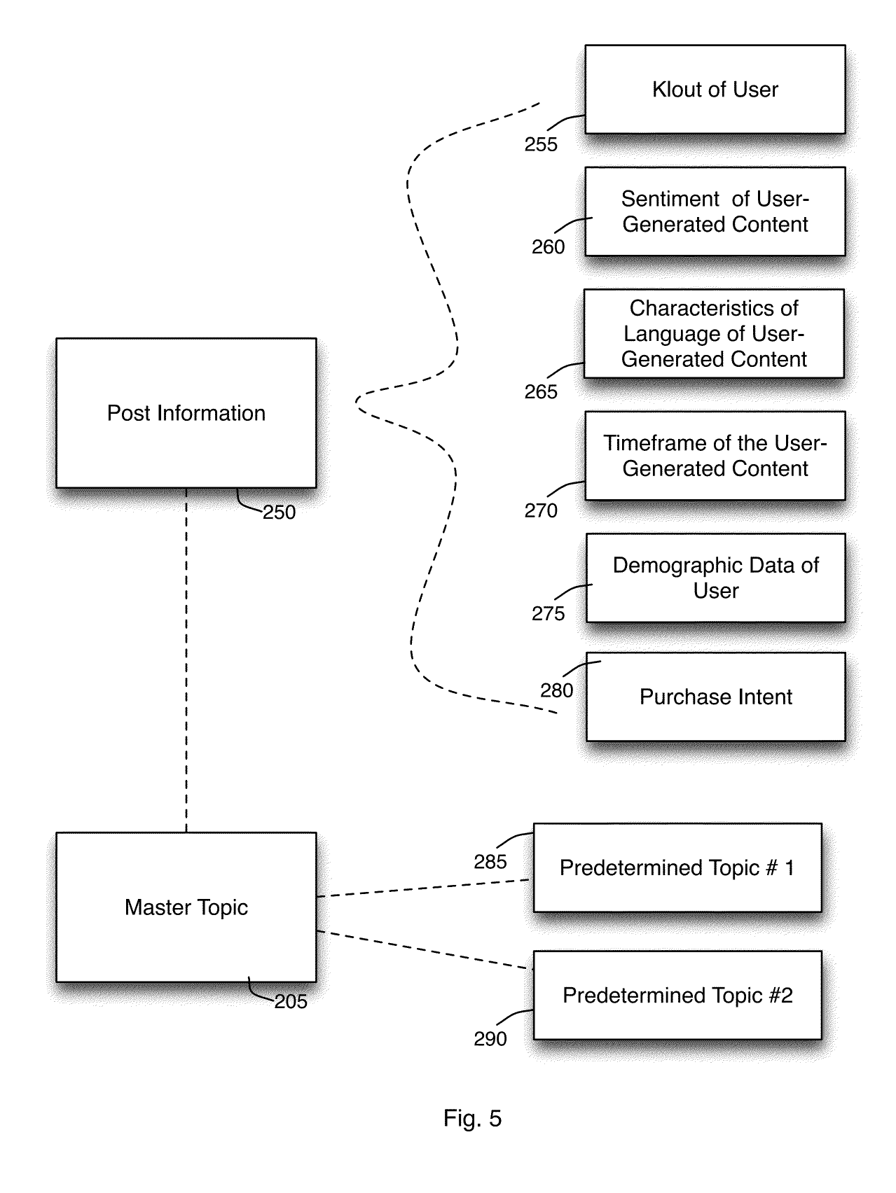

In another embodiment, the master topic 205 may be a combination of predetermined topics that the research enters into the researcher computer 200. Referring to FIG. 5, the master topic 205 may include predetermined topic #1 (285) and predetermined topic #2 (290). For example, the master topic may include all users following Toyota and Honda on Twitter. In this embodiment, the audience of the master topic 205 includes all users following Toyota and all users following Honda on Twitter and the server computer 5 uses the combined users to find the correlations between the master topic 205 and the predetermined topics (except the master topic). It should be understood that the master topic 205 does not have to be limited to one or two predetermined topics 285 and 290. The master topic 205 may include any number of predetermined topics 285 and 290. In another embodiment, the master topic 205 may include any number of predetermined topics 285 and 290 and post information 250. In this embodiment, the audience of the master topic 205 may be, for example, users that tweet 20 about Toyota (predetermined topic) and have a positive sentiment 260 in the tweet 20. Similarly, the audience of the master topic 205 may be, for example, users that tweet 20 about Seinfeld (predetermined topic) and have a positive sentiment 260 in the tweet 20. The ability to input multiple predetermined topics and different post information 250 allows the researcher to find information and interest about specifically targeted users.

Referring back to FIG. 4, the researcher may enter a correlation threshold 210 into the research computer 200 that is transmitted to the server computer 5 over the data network 10. In this embodiment, the server computer 5 uses the correlation threshold 210 to limit the marketing research information provided to the researcher. For example, the researcher may only want to see predetermined topics that have at least 25% of users interested in the predetermined topic also interested in the master topic. In addition, the researcher may enter a user information selection 210. In this embodiment the server computer 5 may order or format the marketing research information based on the user information in the predetermined topic audience. For example, the researcher may select purchase intent and the information provided to the researcher computer will be ordered or ranked based on how many users in the predetermined topic audience intend to purchase the predetermined topic. In another embodiment, the user may input an accumulation selection 220. The accumulation selection 220 is similar to the user information selection 210, but instead of ordering the marketing research information, the marketing research information is narrowed. In this embodiment the marketing research information provided to the researcher computer 200 is limited to the accumulation selection 220 input into the researcher computer 200. The accumulation selection 220 may be, for example, a time limitation or a demographic limitation that causes only post information meeting the accumulation selection to be accumulated in the master topic affinity table. For example, marketing research information is provided by the server computer 5 may be limited to users in the predetermined topic audience that post their user-generated content within a selected week or that use positive sentiment with regard to the predetermined topic 205. In another example, marketing research information is provided by the server computer 5 may be limited to users interested in predetermined topics that are located in a certain area and tweet 20 about the predetermined topic 205.

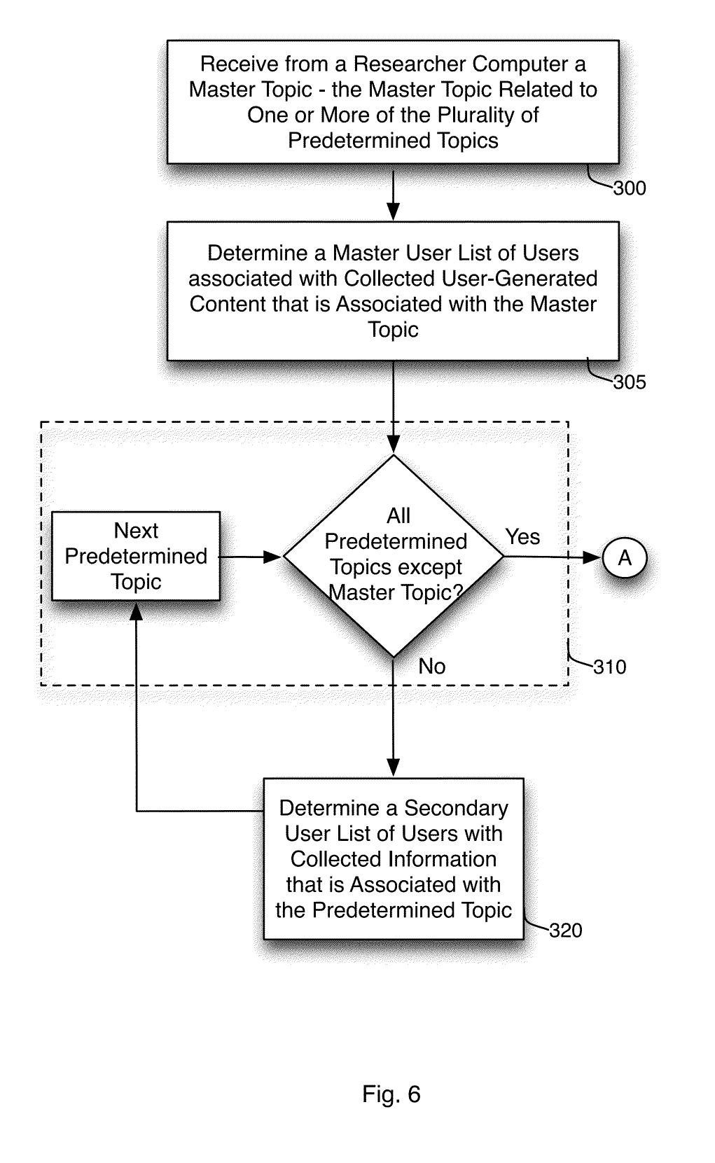

Referring to FIG. 6, a flowchart of the method of the embodiment of FIG. 4 is shown. The method includes receiving from the researcher computer 200 the master topic 205 (step 300). As described above, the master topic 205 may be any combination of predetermined topics and post information 250. The method further includes the steps of determining a master user list of users associated with the master topic 205 (step 305). After determining the master user list (step 305), the method loops through each of the predetermined topics except for the master topic 205 (step 310), to determine secondary user lists of users associated with each of the predetermined topics except the master topic 205 (step 320). The master user list and the secondary user lists may be determined from user information 15 stored in the audience database associated with each predetermined topic 40, 45, and 50. Typically the user information 15 used would be user identity information 230 such as a Twitter handle. However, it should be understood that the predetermined topic user list may be determined from a combination of predetermined topics and/or post information 250 similar to the determination of the master topic user list.

Once the master user list and the secondary user lists are determined, a correlation is determined between the master user list and each secondary user list. Referring to FIG. 6, the method further includes for each of the plurality of the predetermined topics except for the master topic 205 (step 400), and for all the users in the master user list (step 405), determining if the user in the master user list is also in the secondary user list (step 410). If the user in the master user list is in the secondary user list (step 410), then updating the correlation (step 415) and in some embodiments, accumulating post information 250 associated with the predetermined topic (step 420), and storing the predetermined topic, the correlation, and in some embodiments the post information 250 in a master topic affinity table (step 425). In one embodiment, the correlation associated with the predetermined topic includes at least one match between user information 15 in the master user list and user information 15 in the secondary user list associated with the predetermined topic. Updating the correlation (step 415) may include increasing the count of matches between user information 15 in the master user list and user information 15 in the secondary user list associated with the predetermined topics. The accumulating of post information 250 (step 420) may be an addition of the post information 250, or an average of the post information 250. The method also includes the step of transmitting to the researcher computer 200 marketing research information determined from the master topic affinity table (step 435). The storage of the master user list, the secondary user lists, and the accumulation of post information may be performed by a realtime search engine and database web application, such as Sensei.

The marketing research information may be equivalent to the master topic affinity table or it may be a formatted version of the master topic affinity table that can be displayed by the researcher computer 200. The method may include in some embodiments ordering or formatting the marketing research information determined from the master topic affinity table (step 430) (or the master topic affinity table may be what is ordered). The ordering or ranking may be based on the correlation. For example, if fans of the hybrid car talk about food item M twice as much as alcoholic beverage item N, then the ranked marketing research information may reflect that food item M has a higher ranking than alcoholic beverage item N. This may indicate to the researcher (i.e. advertisers) that food item M may generate more successful results from advertising to fans of hybrid cars. As described above hybrid cars may be a combination of predetermined topics. Similarly, ordering or ranking may be based on the post information 250. For example, if fans of the hybrid car talk about food item M in a more positive manner than beverage item N, then the ranked marketing research information may reflect that food item M has a higher ranking than alcoholic beverage item N. This may indicate to the researcher that food item M may generate more successful results from advertising to fans of the hybrid car.

Furthermore, the researcher may limit the correlation and/or the post information 250. For example, the researcher may only want to consider user-generated information from users who are women or who are over the age of 18. For example, many people may have opinions about hybrid cars, food item M, and beverage N, the researcher may be targeting women purchasers and therefore would want to limit the opinions about hybrid cars, food item M, and beverage N specifically to women. Similarly, the researcher may want to consider user-generated content 225 at a time before or after an event. For example the researcher may be interested in finding out if fans of the Seinfeld pay attention to advertisements on TV more than advertisements on a website such as Hulu. The ranking of an item can be determined after a commercial airs on the Hulu website showing Jerry Seinfeld promoting the item and the ranking of the item can be determined at another time after a commercial airs on TV showing Jerry Seinfeld promoting the item. One skilled in the art would understand that, similar to the predetermined Audience databases, the user lists and the master topic affinity table may be tagged memory locations rather than actual lists and tables stored in contiguous memory locations.

Accordingly, the method of the present invention may provide marketing research information that consists simply of a list of predetermined topics and for each predetermined topic, the number of users that are associated with the master topic 205 that are also associated with the predetermined topic. In addition, the method may provide marketing research information that is much more intricate, incorporating a multitude of characteristic of the user-generated content and allowing a researcher to select, to limit, and to order the marketing research information based on the researcher's needs. This versatility allows the researcher to better understand its target audience, the interests of the target audience, and the emergence of new interests. The method of the present invention also allows the researcher to collect unbiased information because the user-generated content 225 is unsolicited.

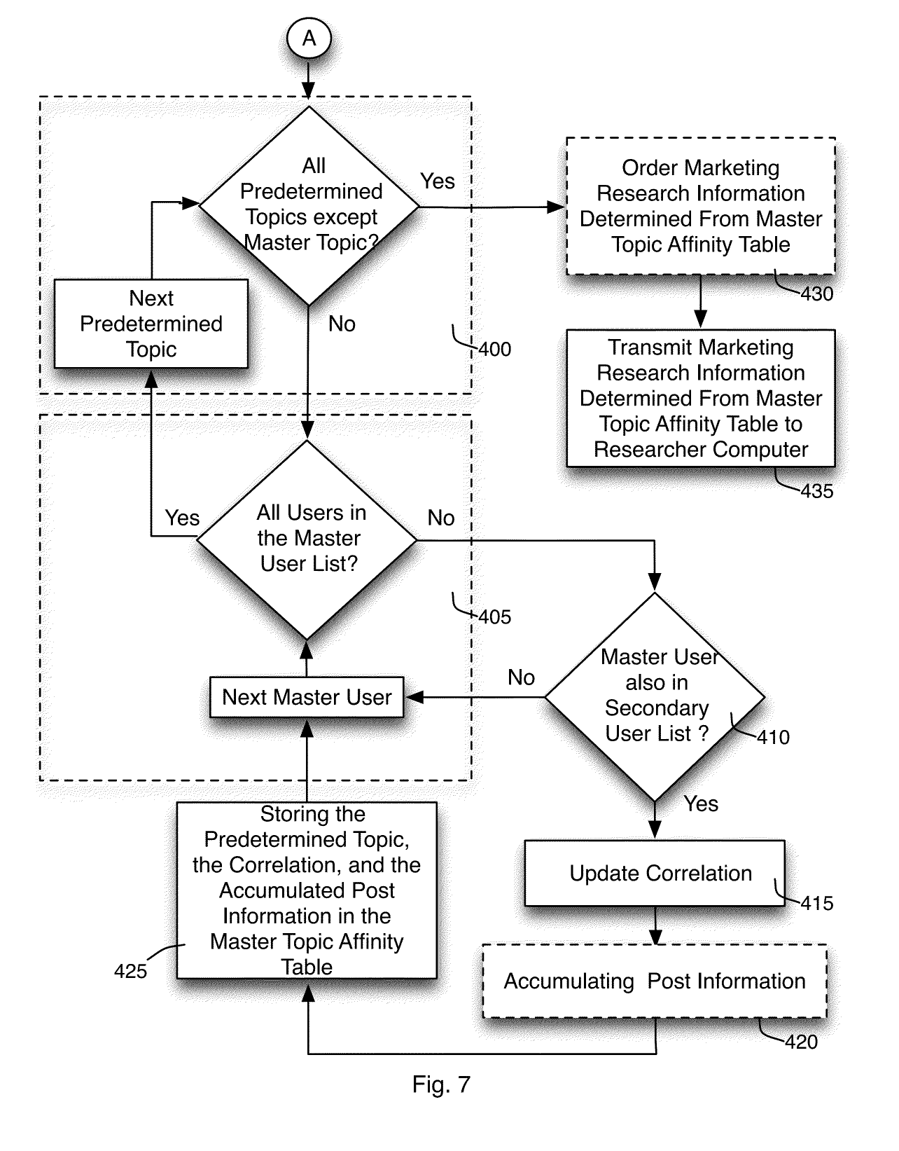

Shown in FIG. 7 is an example of a research computer 200 interface screen. In this example, the master topic 205 is “The Walking Dead.” The interface screen shows the marketing research information 500. The marketing research information 500, in this example, includes the number of master topic users 505, which are followers of the master topic 510. The marketing research information 500 also includes a list of predetermined topics 515 that have a correlation with the master topic. The marketing research information 500 is ordered according to the correlation 520 of users in the master user list 505 and users in the predetermined topic lists 525. The over index 530 shows the relative difference between the number of correlated users for the predetermined topic compared the average number of correlated users for all predetermined topics. Also displayed is demographic data 540 for the master topic 205 and psychographic data 540 for the master topic 205. Although this example shows a simple list of predetermined topics, it should be understood that the information displayed to the researcher may include some or all the post information 250 described above. It should also be understood that the displayed information may be broader and include many characteristics about a user in addition to the post information described above. In addition, the researcher may be able to select what information is displayed and how it is displayed (and ordered as described above).

Although the system implementing the method of the present invention has been described as a server computer 5, it should be understood that the method of the present invention may be executed on any computer system, client terminal and/or network-connected device. The computer system may include a data store that can comprise one or more structural or functional parts that have or support a storage function. For example, the data store can be, or can be a component of, a source of electronic data, such as a document access apparatus, a backend server connected to a document access apparatus, an e-mail server, a file server, a multi-function peripheral device (MFP or MFD), a voice data server, an application server, a computer, a network apparatus, a terminal etc. It should be appreciated that the term “electronic document” or “electronic data” as used herein, in its broadest sense, can comprise any data that a user may wish to access, retrieve, review, etc.

The data network 10 may be provided via one or more of a secure intranet or extranet local area network, a wide area network (WAN), any type of network that allows secure access, etc., or a combination thereof. Further, other secure communications links (such as a virtual private network, a wireless link, etc.) may be used as well as the network connections. In addition, the data network 10 may use TCP/IP (Transmission Control Protocol/Internet Protocol), but other protocols such as SNMP (Simple Network Management Protocol) and HTTP (Hypertext Transfer Protocol) can also be used. How devices can connect to and communicate over the networks is well-known in the art and is discussed for example, in “How Networks Work”, by Frank J. Derfler, Jr. and Les Freed, (Que Corporation 2000), and “How Computers Work”, by Ron White, (Que Corporation 1999), the entire contents of each of which is incorporated herein by reference.

The server computer 5 may be a special purpose device (such as including one or more application specific integrated circuits or an appropriate network of conventional component circuits) or it may be software configured on a conventional personal computer or computer workstation with sufficient memory, processing and communication capabilities to operate as a terminal and/or server, as will be appreciated to those skilled in the relevant arts. The server computer 5 includes a data network 10 interface for communications through a network, such as communications through the network 10. However, it should be appreciated that the subject matter of this disclosure is not limited to such configuration. For example, the computer may communicate with client terminals through direct connections and/or through a network to which some components are not connected. As another example, the devices need not be provided by a server that services terminals, but rather may communicate with the devices on a peer basis, or in another fashion. The system is not limited to a computer or server, but can be manifested in any of various devices that can be configured to communicate over a network and/or the Internet. The system may be any network-connected device including but not limited to a personal, notebook or workstation computer, a terminal, a kiosk, a PDA (personal digital assistant), a tablet computing device, a smartphone, a scanner, a printer, a facsimile machine, a multi-function device (MFD), a server, a mobile phone or handset, another information terminal, etc. Each device may be configured with software allowing the device to communicate through networks with other devices.

An example of a configuration of a multi-function device (MFD) includes a central processing unit (CPU), and various elements connected to the CPU by an internal bus. The CPU services multiple tasks while monitoring the state of the device. The elements connected to the CPU may include a scanner unit, a printer unit, an image processing device, a read only memory (for example, ROM, PROM, EPROM, EEPROM, etc.), a random access memory (RAM), a hard disk drive (HOD), portable media (for example, floppy disk, optical disc, magnetic discs, magneto-optical discs, semiconductor memory cards, etc.) drives, a communication interface (I/F), a modem unit, and an operation panel. Program code instructions for the device can be stored on the read only memory, on the HOD, or on portable media and read by the portable media drive, transferred to the RAM and executed by the CPU to carry out the instructions. These instructions can include the instructions to the device to perform specified ones of its functions and permit the device to interact with other network-connected devices. The operation panel includes a display screen that displays information allowing the user of the device to operate the device. The display screen can be any of various conventional displays (such as a liquid crystal display, a plasma display device, a cathode ray tube display, etc.), but is preferably equipped with a touch sensitive display (for example, liquid crystal display), and configured to provide the GUI based on information input by an operator of the device, so as to allow the operator to conveniently take advantage of the services provided by the system. The display screen does not need to be integral with, or embedded in, the operation panel, but may simply be coupled to the operation panel by either a wire or a wireless connection. The operation panel may include keys for inputting information or requesting various operations. Alternatively, the operation panel and the display screen may be operated by a keyboard, a mouse, a remote control, touching the display screen, voice recognition, or eye-movement tracking, or a combination thereof. The device may be a multifunction device (with scanner, printer and image processing) and in addition can be utilized as a terminal to download documents from a network.

Although the preferred embodiments of the invention have been described above by way of example only, it will be understood by those skilled in the art that modifications may be made to the disclosed embodiments without departing from the scope of the invention. For example, the post information 250 may include many other measurements and characteristics. The determination of the secondary user list (steps 310 and 320) may be performed prior to determining the master user list (step 305). Additionally, the marketing research information may be transmitted to a different computer on the data network 10 instead of or in addition to the researcher computer 200.

Furthermore, various embodiments described herein or portions thereof can be combined without departing from the present invention. For example, the collected user information may be determined from collected and stored user-generated content 225. Likewise, the master topic affinity table may include a variety of post information 250 and some of the post information 250 may be limited by the researcher while other post information 250 may not limited by the researcher.

The above-described embodiments of the present invention are presented for purposes of illustration and not of limitation, and the present invention is limited only by the claims that follow.

What is claimed is:

1. A computer-implemented method for performing marketing research, comprising a server computer performing the steps of:
collecting user-generated content from a data network, the user-generated content associated with a user;
for each of a plurality of predetermined topics, determining if the user-generated content comprises the predetermined topic; and
if the user-generated content comprises the predetermined topic, storing in an audience database associated with the predetermined topic:
user information associated with the user, and
the user-generated content comprising the predetermined topic.

2. The method of claim 1, wherein the user-generated content comprises following at least one of the plurality of predetermined topics.

3. The method of claim 1, wherein the user information comprises identity information.

4. The method of claim 1, further comprising the steps of:
receiving from a researcher computer a master topic, the master topic comprising one or more of the plurality of predetermined topics;
determining a master user list of user information stored in the audience database associated with the master topic;
for each of the plurality of the predetermined topics except for the master topic, determining a secondary user list of user information stored in the audience database associated with the predetermined topic;
for each of the plurality of the predetermined topics except for the master topic, determining a correlation associated with the predetermined topic and storing the predetermined topic and its associated correlation in a master topic affinity table; and
transmitting to the researcher computer marketing research information determined from the master topic affinity table.

5. The method of claim 4, wherein the correlation associated with the predetermined topic comprises at least one match between user information in the master user list and user information in the secondary user list associated with the predetermined topic.

6. The method of claim 4, wherein the predetermined topic and its associated correlation is stored in the master topic affinity table when the associated correlation is greater than a correlation threshold.

7. The method of claim 4, further comprising formatting the marketing research information based on the associated correlations.

8. The method of claim 4, wherein the user information comprises post information determined from user-generated content and further comprising storing an accumulation of the post information in the master topic affinity table.

9. The method of claim 8, wherein the post information comprises a sentiment associated with the predetermined topic.

10. The method of claim 8, wherein the post information comprises characteristics of language associated with the predetermined topic.

11. The method of claim 8, wherein the post information comprises purchase intent information associated with the predetermined topic.

12. The method of claim 8, wherein the post information comprises the number of user-generated content containing the predetermined topic.

13. The method of claim 8, wherein the post information comprises demographic data about the user associated with the user-generated content.

14. The method of claim 8, wherein the post information comprises a timeframe of the user-generated content.

15. The method of claim 4, further comprising receiving from the researcher computer a user information selection and formatting the marketing research information based on the user information selection.

16. The method of claim 4, further comprising receiving from the researcher computer an accumulation selection and wherein the accumulation of the user information is based on the accumulation selection.

17. The method of claim 4, wherein the master topic comprises at least one of the plurality of predetermined topics and user information.

18. A server computer for performing marketing research, the server computer programmed to:
collect user-generated content from a data network, the user-generated content associated with a user;
for each of a plurality of predetermined topics, determine if the user-generated content comprises the predetermined topic; and
if the user-generated content comprises the predetermined topic, store in an audience database associated with the predetermined topic:
user information associated with the user, and
the user-generated content comprising the predetermined topic.

19. The system of claim 18, wherein the user-generated content comprises following at least one of the plurality of predetermined topics

20. The system of claim 18, wherein user information comprises identity information.

21. The system of claim 18, the server computer further programmed to:
receive from a researcher computer a master topic, the master topic comprising one or more of the plurality of predetermined topics;
determine a master user list of user information stored in the audience database associated with the master topic;
for each of the plurality of the predetermined topics except for the master topic, determine a secondary user list of user information stored in the audience database associated with the predetermined topic;
for each of the plurality of the predetermined topics except for the master topic, determine a correlation associated with the predetermined topic and store the predetermined topic and its associated correlation in a master topic affinity table; and
transmitting to the researcher computer, marketing research information determined from the master topic affinity table.

22. The system of claim 21, wherein the correlation associated with the predetermined topic comprises at least one match between user information in the master user list and user information in the secondary user list associated with the predetermined topic.

23. The system of claim 21, wherein the predetermined topic and its associated correlation is stored in the master topic affinity table when the associated correlation is greater than a correlation threshold.

24. The system of claim 21, the server computer further programmed to format the marketing research information based on the associated correlations.

25. The system of claim 21, wherein the user information comprises post information determined from user-generated content and the server computer further programmed to store an accumulation of the post information in the master topic affinity table.

26. The system of claim 25, wherein the post information comprises a sentiment associated with the predetermined topic.

27. The system of claim 25, wherein the post information comprises characteristics of language associated with the predetermined topic.

28. The system of claim 25, wherein the post information comprises purchase intent information associated with the predetermined topic.

29. The system of claim 25, wherein the post information comprises the number of posts containing the predetermined topic.

30. The system of claim 25, wherein the post information comprises demographic data about the user associated with the user-generated content.

31. The system of claim 25, wherein the post information comprises a timeframe of the user-generated content.

32. The system of claim 21, the server computer further programmed to receive from the researcher computer a user information selection and format the marketing research information based on the user information selection.

33. The system of claim 21, the server computer further programmed to receive from the researcher computer an accumulation selection and wherein the accumulation of the user information is based the accumulation selection.

34. The system of claim 21, wherein the master topic comprises at least one of the plurality of predetermined topics and user information.
